(19) United States
(12) Patent Application Publication
(10) Pub. No.: US 2015/0108386 A1
(43) Pub. Date: Apr. 23, 2015

(54) DIAPHRAGM AND DIAPHRAGM VALVE

(71) Applicant: KABISHIKI KAISHA FUJIKIN, OSAKA (JP)

(72) Inventors: Shunji Obara, Osaka (JP); Yoshinori Shimomura, Osaka (JP); Masahiko Sogao, Osaka (JP); Keigo Kobayashi, Osaka (JP)

(21) Appl. No.: 14/404,206

(22) PCT Filed: Mar. 21, 2013
(86) PCT No.: PCT/JP2013/058019

§ 371 Date: Nov. 26, 2014

(30) Foreign Application Priority Data
May 30, 2012 (JP) 2012-123793

(51) Int. Cl. F16K 7/12

(52) U.S. Cl. CPC F16K 7/12
USPC 251/331

(57) ABSTRACT

A diaphragm with excellent durability is provided which can restrain occurrence of a crack resulting from up and down movements of the diaphragm with opening and closing of a flow channel of a diaphragm valve, and a diaphragm valve having this diaphragm.

The diaphragm is attached to a diaphragm valve, comprising a membrane part deforming and moving up and down with opening and closing of a flow channel and a flange part which is provided around said membrane part and sandwiched between a valve body and a bonnet, wherein the diaphragm is formed in a curved surface shape where the shape before deformation of the lower surface of said membrane part descends and then ascends from an outer edge part towards a central part.

### TECHNICAL FIELD

The present invention relates to a diaphragm and a diaphragm valve, more particularly a diaphragm with high durability which can restrain of sealing properties and occurrence of a crack resulting from repeated opening and closing of a flow channel of the diaphragm valve, and a diaphragm valve.

### BACKGROUND OF THE INVENTION

Generally, a diaphragm attached to a diaphragm valve is manufactured by molding materials, such as rubber and resin, in predetermined shape using a metallic mold.

Usually, a molding of a diaphragm is performed in any of a shape of a descended diaphragm (with a flow channel closed) (molding in a closed shape) or a shape of an ascended diaphragm (with a flow channel opened) (molding in an opened shape).

The diaphragm manufactured by the molding in a closed shape is in a downwardly carved shape (for example, see FIG. 19 of the following Patent Document 1), and the diaphragm manufactured by the molding in an opened shape is in an upwardly carved shape (for example, see FIG. 8 of the following Patent Document 2).

However, such conventional diaphragm in a downwardly or upwardly carved shape deforms largely with up and down movements of the diaphragm by an opening and closing operation of the diaphragm valve. Thus, the diaphragm molded in a downwardly carved shape deforms largely in an upward direction in opening the flow channel, and the diaphragm molded in a upwardly carved shape deforms largely in a downward direction in closing the flow channel.

Therefore, if the opening and closing operation of the diaphragm valve is repeated, large deformation repeatedly occurs in the diaphragm. Thus, there was a problem that a crack is likely to occur around the outer edge of the curved part which becomes a base end of deformation.

Moreover, in order to improve durability of the diaphragm by enhancing the strength thereof, a diaphragm containing cloth which is reinforced by foundation cloth, consisting of rubber materials, is provided (for example, see the following Patent Document 2).

In such diaphragm containing cloth, the foundation cloth needs to be placed in a substantially intermediate position in a thickness direction so as to follow the shape of the diaphragm. Thus, if the position of the foundation cloth is deviated, sufficient strength cannot be obtained, resulting in no improvement effects of durability.

However, the above-mentioned conventional diaphragm in a downwardly or upwardly carved shape has a large curve, thus there was a difficulty in placing the foundation cloth in a substantially intermediate position in a thickness direction so as to follow the shape of the diaphragm. In particular, there was a problem that the foundation cloth deviated downwardly from the intermediate position in a thickness direction around the center of the diaphragm.

### PRIOR ART DOCUMENTS

### Patent Documents

Patent Document 1: Japanese Patent No. 4232939

Patent Document 2: Japanese Unexamined Patent Application Publication No. 2002-264141

### SUMMARY OF THE INVENTION

### Problems to be Solved by the Invention

The present invention is to solve the above-mentioned problems of prior art and provide a diaphragm with excellent durability which can restrain occurrence of a crack resulting from up and down movements of the diaphragm with opening and closing of a flow channel of a diaphragm valve, and a diaphragm valve having this diaphragm.

### Means for Solving the Problems

The invention according to claim 1 is a diaphragm attached to a diaphragm valve and relates to a diaphragm, comprising a membrane part deforming and moving up and down with opening and closing of a flow channel and a flange part which is provided around said membrane part and sandwiched between a valve body and a bonnet, wherein the diaphragm is formed in a curved surface shape where the shape before deformation of the lower surface of said membrane part descends and then ascends from an outer edge part towards a central part.

The invention according to claim 2 relates to a diaphragm of claim 1, wherein a vertical direction distance between the positions of the uppermost part and the lowest part of the lower surface of said membrane part is a distance of 10% or less to the diameter of said membrane part.

The invention according to claim 3 relates to a diaphragm of claim 1 or 2, wherein the diaphragm includes a reinforcing cloth at a substantially intermediate position in a thickness direction.

The invention according to Claim 4 relates to a diaphragm of claim 3, wherein said reinforcing cloth consists of nylon.

The invention according to Claim 5 relates to a diaphragm of any of Claim 1 or 2, wherein the surface of the diaphragm is coated in a thin film state with a resin film.

The invention according to Claim 6 relates to a diaphragm valve having the diaphragm of any of Claims 1 to 5.

### EFFECTS OF THE INVENTION

According to the invention of claim 1, the diaphragm is formed in a curved surface shape where the shape before deformation of the lower surface of the membrane part, which deforms and moves up and down with the opening and closing of the flow channel, descends and then ascends from the outer edge part towards the central part, so that an amount of the deformation with the up and down movements of the diaphragm by an opening and closing operation of the diaphragm valve can be reduced, compared with a diaphragm in a curved shape only in the conventional upward or downward direction. Accordingly, even though the opening and closing operation of the diaphragm valve is repeated, a crack is less likely to occur to the diaphragm, thereby obtaining a diaphragm with excellent durability.

Also, the curve of the diaphragm according to the present invention is smaller compared with the conventional diaphragms. Thus, it becomes easy to place the reinforcing cloth at a substantially intermediate position in a thickness direction so that the reinforcing cloth follows the shape of the diaphragm in molding. Accordingly, a reinforcement effect can be exhibited by the reinforcing cloth, thereby obtaining an improvement effect of excellent durability.

According to the invention of claim 2, the vertical direction distance between the positions of the uppermost part and the lowest part of the lower surface of the membrane part is a distance of 10% or less to the diameter of the membrane part, so that an amount of the deformation with the up and down movements of the diaphragm by the opening and closing operation of the diaphragm valve can be substantially reduced, thereby obtaining a diaphragm with very excellent durability.

According to the invention of claim 3, the diaphragm includes a reinforcing cloth at a substantially intermediate position in a thickness direction, so that a reinforcement effect can be sufficiently exhibited by the reinforcing cloth, thereby obtaining a diaphragm with excellent durability.

According to the invention of claim 4, the reinforcing cloth consists of nylon, so that a high reinforcement effect can be exhibited by the reinforcing cloth, thereby obtaining a diaphragm with very excellent durability.

According to the invention of claim 5, the surface of the diaphragm is coated in a thin film state with the resin film, so that a reinforcement effect can be exhibited by the resin film, thereby obtaining a diaphragm with excellent durability.

According to the invention of claim 6, the diaphragm valve has the diaphragm of any of claims 1 to 5, so that it becomes a diaphragm valve having a diaphragm with excellent durability.

### BRIEF DESCRIPTION OF FIGURES

FIG. 1 shows views illustrating a diaphragm according to the present invention. (a) is a top view, (b) is a sectional view taken along the line A-A of (a), and (c) is a bottom view.

FIG. 2 (a) is an enlarged view in the circle of FIG. 1 (b) and (b) shows the change example.

FIG. 3 is a partial enlarged view of the diaphragm according to the present invention and a bonnet which presses down the diaphragm from upward.

FIG. 4 is a top view (top view common to a mounting state, a full opened flow channel state, and a full closed flow channel state) showing a diaphragm valve having the diaphragm according to the present invention.

FIG. 5 shows views illustrating the mounting state of the diaphragm valve having the diaphragm according to the present invention. (a) is a sectional view taken along the line A-A of FIG. 4 and (b) is a sectional view taken along the line B-B line of FIG. 4.

FIG. 6 shows views illustrating the full opened flow channel state of the diaphragm valve having the diaphragm according to the present invention. (a) is a sectional view taken along the line A-A of FIG. 4 and (b) is a sectional view taken along the line B-B of FIG. 4.

FIG. 7 shows views illustrating the full closed flow channel state of the diaphragm valve having the diaphragm according to the present invention. (a) is a sectional view taken along the line A-A of FIG. 4 and (b) is a sectional view taken along the line B-B of FIG. 4.

### DETAILED DESCRIPTION OF THE INVENTION

Hereinafter, suitable embodiments of the diaphragm and the diaphragm valve according to the present invention will be explained with reference to the drawings.

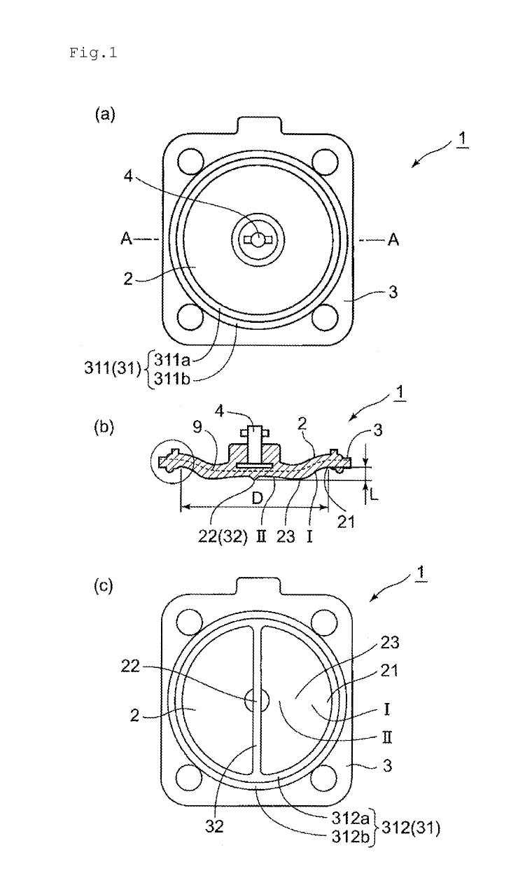

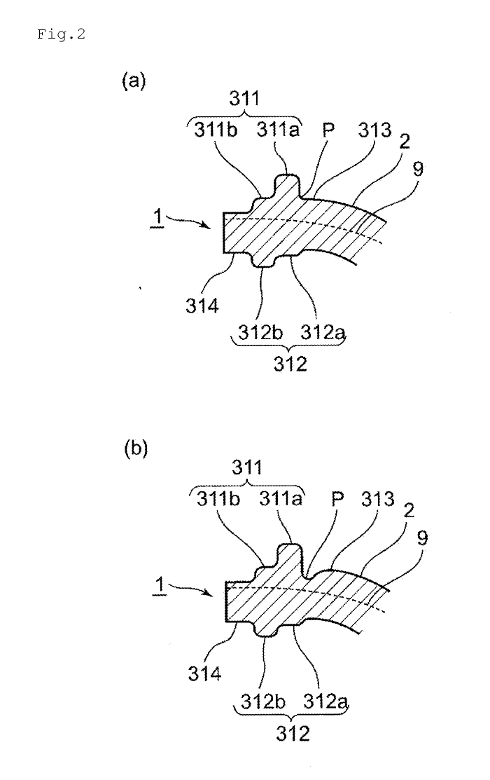

FIG. 1 shows views illustrating a diaphragm according to the present invention. (a) is a top view, (b) is a sectional view taken along the line A-A of (a), and (c) is a bottom view. FIG. 2 (a) is an enlarged view in the circle of FIG. 1 (b) and (b) shows the change example.

A diaphragm (1) according to the present invention comprises a membrane part (2) deforming and moving up and down with opening and closing of a flow channel of a diaphragm valve and a flange part (3) which is provided around this membrane part (2) and sandwiched between a valve body and a bonnet of a diaphragm. valve.

The diaphragm (1) according to the present invention has a feature in a shape before deformation of the membrane part (2).

“A shape before deformation” is a shape of the membrane part (2) before attaching the diaphragm to the diaphragm valve, in other words, a shape in molding a metallic mold of the diaphragm. FIGS. 1, 2 and 5 show the shapes before deformation.

The diaphragm (1) according to the present invention is formed in a curved surface shape where the shape before deformation of the lower surface of the membrane part (2) descends and then ascends from an outer edge part (21) towards a central part (22).

In particular, the lower surface of the membrane part (2) is positioned in the lowermost position in the intermediate part (23) between the outer edge part (21) and the central part (22), as shown in FIG. 1 (b), formed in a curved surface shape to descend from the outer edge part (21) towards the intermediate part (23) (referred as a first curved surface (I)), and formed in a curved surface shape to ascend from the intermediate part (23) towards the central part (22) (referred as a second curved surface (II)). In other words, the lower surface of the diaphragm (1) is formed in a curved surface shape where it has longitudinal plane shapes which are consecutive in a substantially W shape.

The first curved surface (I) and the second curved surface (II) are consecutively provided. The vertical ridge (32) is formed on the central part (22), which will be mentioned below. The first curved surface (I) descends from the outer edge part (21) towards the intermediate part (23). After the second curved surface (II) ascends from the intermediate part (23) towards inward direction (central direction) to reach the vertical ridge (32), it descends towards the central part (22) in the vertical ridge (32).

The second curved surface (II) is in an upper position from the intermediate part (23) except the central part (22), and the central part (22) is in a substantially equal position to the intermediate part (23) in a vertical direction.

In addition, in the present invention, a vertical direction is a direction along a stem axis of the diaphragm valve, an upward direction is a direction in which a suspending metal fitting (4) linked with the stem of the diaphragm valve protrudes (an upward direction in FIG. 1 (b)), and a downward direction is an opposite direction of the upward direction (an downward direction in FIG. 1 (b)).

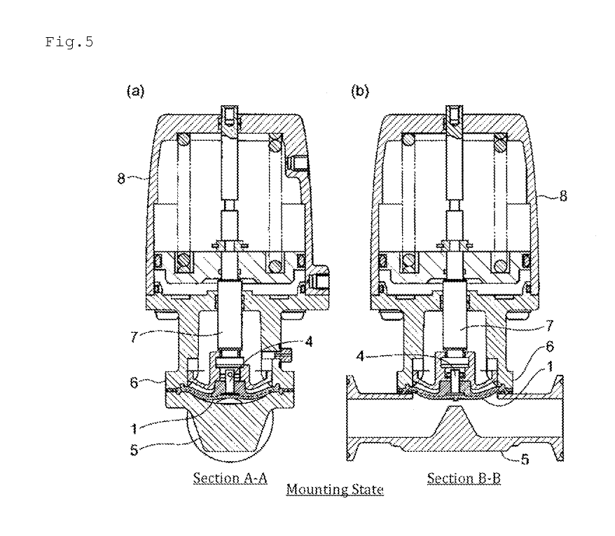

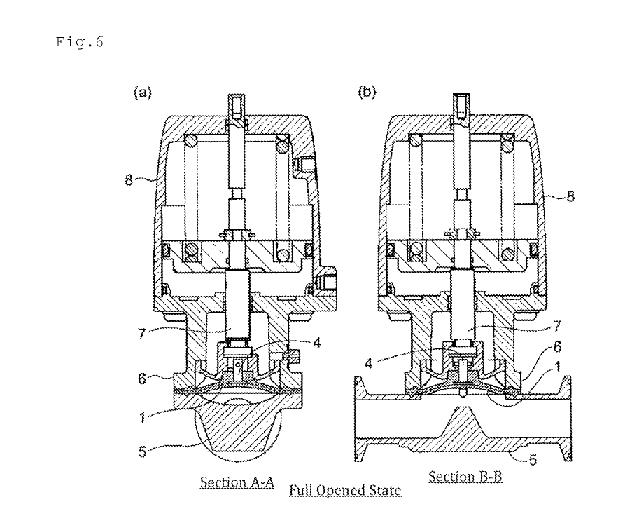

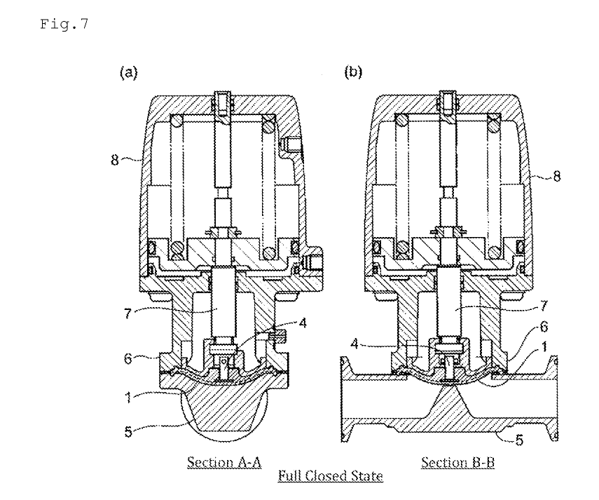

FIGS. 4 to 7 are views showing a diaphragm valve having the diaphragm (1) according to the present invention. FIG. 4 is a top view of the diaphragm valve (a top view common to a mounting state, a full opened flow channel state, and a full closed flow channel state). FIGS. 5 to 7 are views showing the mounting state (FIG. 5), the full opened flow channel state (FIG. 6), and the full closed flow channel state (FIG. 7) of the diaphragm valve having the diaphragm according to the present invention, respectively, and in each figure, (a) is a sectional view taken along the line A-A of FIG. 4 and (b) is a sectional view taken along the line B-B of FIG. 4.

The diaphragm valve comprises a valve body (5) having a flow channel for fluid circulation, a diaphragm (1) which opens and closes the flow channel by abutting on and separating away from the flow channel, a bonnet (6) which sandwiches and fixes a flange part (3) of the diaphragm (1) between the valve body (5) and the bonnet (6), a stem (7) connected to the diaphragm (1) via a suspending metal fitting (4), and an operating mechanism (8) for moving up and down the stem (7).

Although, as an operating mechanism (8), a pneumatic actuator is shown in FIGS. 4 to 7, the operating mechanism (8) is not be limited to this and may be a manual handle, etc.

The diaphragm (1) according to the present invention is formed in a curved surface shape where the shape before deformation of the lower surface of the membrane part (2) descends and then ascends from the outer edge part (21) towards the central part (22), so that an amount of the deformation of the membrane part (2) with up and down movements of the diaphragm (1) decreases, compared with a diaphragm in a curved shape only in the conventional upward or downward direction, as can be understood from FIGS. 5 to 7.

Accordingly, even though the opening and closing operation of the diaphragm valve is repeated, a crack is less likely to occur to the diaphragm (1), thereby obtaining a diaphragm with excellent durability.

As shown in FIG. 1 (b), in the diaphragm (1) according to the present invention, the uppermost part of the lower surface of the membrane part (2) is positioned in the outer edge part (21) of the membrane part (2), and the lowest part is positioned in the intermediate part (23) between the outer edge part (21) and the central part (22).

It is preferable that a vertical direction distance (L) between the positions of the uppermost part and the lowest part of the lower surface of the membrane part (2) is a distance of 10% or less to the diameter (D) of the membrane part (2) . Also, the diameter (D) of the membrane part (2) is equal to the internal diameter of a part which abuts on the diaphragm (1) of the bonnet (6).

In this way, by reducing a degree of the curve as a whole membrane part (to be 10% or less), an amount of the deformation of the membrane part (2) with up and down movements of the diaphragm (1) decreases largely, and thus, an improvement effect of durability can be securely obtained.

However, if the degree of the curve is too small, it possibly becomes difficult to securely open and close the flow channel. Thus, it is more preferable to set the distance (L) within a range of 5 to 10% to the diameter (D). For example, if the diameter (D) is φ54 mm, the distance (L) is set as about 5 mm.

A quality of the material of the diaphragm (1) according to the present invention is not specifically limited, and thus, rubber materials, such as a natural rubber, a nitrile rubber, a styrene rubber, a fluoro rubber (FPM), an ethylene propylene diene monomer rubber (EPDM), etc. are conveniently used.

The diaphragm (1) according to the present invention may be a diaphragm having a single-layer structure which consists of the above-mentioned rubber materials and may be a diaphragm having a two-layer structure in which a rubber membrane consisting of the above-mentioned rubber materials and a synthetic resin membrane such as a polytetrafluoroethylene resin (PTFE) are laminated.

FIGS. 1 and 2 show the diaphragm having a single-layer structure which consists of rubber materials.

The diaphragm (1) includes a reinforcing cloth (9) at a substantially intermediate position in a thickness direction of the diaphragm (1) so that the reinforcing cloth (9) substantially follows the shape of the diaphragm (1). The reinforcing cloth (9) is shown by the dashed line.

The curve of the diaphragm (1) according to the present invention is smaller compared with the conventional diaphragms, as mentioned above. Thus, it becomes easy to place the reinforcing cloth (9) at a substantially intermediate position in a thickness direction so that the reinforcing cloth (9) follows the shape of the diaphragm in molding a metallic mold. Accordingly, a reinforcement effect can be exhibited by the reinforcing cloth, thereby obtaining an improvement effect of excellent durability.

A quality of the material of the reinforcing cloth (9) is not specifically limited, and thus, a carbon fiber, a synthetic resin, a metal, a carbon fiber, etc. can be used, but in particular, a nylon is conveniently used which is excellent in durability against repeated deformation of the diaphragm.

Moreover, in order to improve durability, the surface of the diaphragm may be coated in a thin film state with the resin film (not shown). A PTFE film is conveniently used for the resin film.

The flange part (3) of the diaphragm (1) is provided with an annular ridge (31) and a vertical ridge (32) which is vertical to the annular ridge (31).

The annular ridge consists of an upper ridge (311) protruding upward and a lower ridge (312) protruding downward from a position corresponding to the upper ridge (311) in a radial direction of the diaphragm (1). Besides, the vertical ridge (32) protrudes downward only.

The upper ridge (311) has an inner upper ridge (311a) and an outer upper ridge (311b) with its protruding height being lower than the inner upper ridge (311a), which are consecutively formed in a staircase pattern.

Therefore, the outer upper ridge (311b) can restrain deformation of the inner upper ridge (311a) to generate stress relaxation to the inner upper ridge (311a), so that reduction of sealing properties can be prevented. As a result, a diaphragm with excellent durability can be obtained.

Besides, the “height” in the specification is defined so that “upper parts are higher than lower parts” on the upper surface of the diaphragm and “lower parts are higher than upper parts” in the lower surface of the diaphragm.

The height of the inner vicinity part (313) of the inner upper ridge (311a) is lower than that of the outer upper ridge (311b).

Therefore, application of large stress to the root part (P) of the inner vicinity part (313) of the inner upper ridge (311a) can be prevented. Accordingly, a crack can be prevented more securely from occurring in a short period of time with the root part (P) as a starting point, so that a diaphragm with further excellent durability can be obtained.

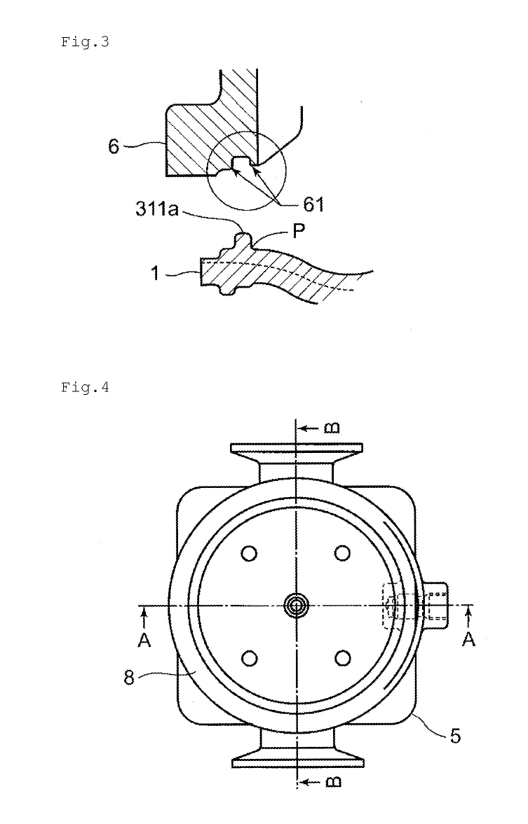

Hereinafter, the crack occurrence in the above-mentioned diaphragm will be explained in more detail with reference to FIG. 3, etc.

When the diaphragm (1) is mounted to the diaphragm valve (see FIGS. 5 to 7), the upper surface of the diaphragm (1) is pressed down by a bonnet (6).

The lower surface of the bonnet (6), which abuts on the diaphragm (1), is provided with a groove for alignment of the inner upper ridge (311a) to be fitted therein, as shown in the circle of FIG. 3. When an inner edge part (61) of this groove abuts on an inner root part (P) of the inner upper ridge (311a) of the diaphragm (1), large stress is applied to the inner root part (P) in deforming the diaphragm, which becomes a starting point of crack occurrence.

In the present invention, the height of the inner vicinity part (313) of the inner upper ridge (311a) is lower than that of the outer upper ridge (311b), so that the edge part (61) of the groove for alignment does not abut on the root part (P) of the inner upper ridge (311a) and a crack can be prevented from occurring with the root part (P) as a starting point.

The height of the root part (P) of the inner upper ridge (311a) may become gradually lower from the inner upper ridge (311a) towards the inner vicinity part (313) (see FIG. 2 (a)) or may become once lower from the inner upper ridge (311a) towards the inner vicinity part (313) and then dented (see FIG. 2 (b)).

The lower ridge (312) has an inner lower ridge (312a) and an outer lower ridge (312b) with its protruding height being higher than the inner lower ridge (312a), which are consecutively formed in a staircase pattern. Therefore, the inner lower ridge (312a), which functions as a sealing surface, can be securely and tightly contacted with respect to the valve body (5) with its wide area contacted, thereby improving sealing properties.

The protruding height of the inner lower ridge (312a) is higher than that of the outer vicinity part (314) of the outer lower ridge (312b).

Therefore, the inner lower ridge (312a), which functions as a sealing surface, can be tightly contacted with respect to the valve body (5) with high pressure, thereby improving sealing properties.

However, in the present invention, the shape of the ridge of the diaphragm is not limited to that in the examples of the figures, and thus, known various shapes of ridge can be suitably adopted unless departing from the scope of the invention.

Moreover, the diaphragm valve according to the present invention is not limited to a weir type diaphragm valve in which a valve seat rises in the flow channel as shown in the examples of the figures, and thus, it may be a diaphragm valve without the risen valve seat.

### INDUSTRIAL APPLICABILITY

The present invention is conveniently employed for a diaphragm valve used, for example, for opening and closing of a sampling pipe, liquid supply pipe, etc. in an apparatus for culturing microbes.

### EXPLANATIONS OF NUMERALS

1 Diaphragm

2 Membrane Part

21 Outer Edge Part

22 Central Part

23 Intermediate Part

3 Flange Part

4 Suspending Metal Fitting

5 Valve Body

6 Bonnet

7 Stem

8 Operating Mechanism

L Vertical Direction Distance between Positions of Uppermost Part and Lowest Part

D Diameter of Membrane Part

1. A diaphragm attached to a diaphragm valve, comprising;
a membrane part deforming and moving up and down with opening and closing of a flow channel and a flange part which is provided around said membrane part and sandwiched between a valve body and a bonnet,
wherein the diaphragm is formed in a curved surface shape where the shape before deformation of a lower surface of said membrane part descends and then ascends from an outer edge part towards a central part.

2. The diaphragm of claim 1, wherein a vertical direction distance between the positions of an uppermost part and a lowest part of the lower surface of said membrane part is a distance of 10% or less to the diameter of said membrane part.

3. The diaphragm of claim 1, wherein the diaphragm includes a reinforcing cloth at a substantially intermediate position in a thickness direction.

4. The diaphragm of claim 3, wherein said reinforcing cloth comprises nylon.

5. The diaphragm of claim 1, wherein the surface of the diaphragm is coated in a thin film state with a resin film.

6. A diaphragm valve having the diaphragm of claim 1.

7. The diaphragm of claim 2, wherein the diaphragm includes a reinforcing cloth at a substantially intermediate position in a thickness direction.

8. The diaphragm of claim 7, wherein said reinforcing cloth comprises nylon.

9. The diaphragm of claim 2, wherein the surface of the diaphragm is coated in a thin film state with a resin film.

10. A diaphragm valve having the diaphragm of claim 2.

11. A diaphragm valve having the diaphragm of claim 3.

12. A diaphragm valve having the diaphragm of claim 4.

13. A diaphragm valve having the diaphragm of claim 5.

14. A diaphragm valve having the diaphragm of claim 7.

15. A diaphragm valve having the diaphragm of claim 8.

16. A diaphragm valve having the diaphragm of claim 9.
